(19) United States
(12) Patent Application Publication
(10) Pub. No.: US 2005/0251520 A1
(43) Pub. Date: Nov. 10, 2005

(54) Systems and methods for the matching of materials data to parts data

(75) Inventors: Mark Vidov, Toronto (CA); Glenn Morell, Toronto (CA); Dennis Wu, Toronto (CA); David Gray, Sharon (CA)

Correspondence Address: BERESKIN AND PARR, 40 KING STREET WEST, BOX 401, TORONTO, ON, M5H 3Y2, CA

(73) Assignee: NRX Global Corp., Toronto (CA)

(21) Appl. No.: 10/840,278

(22) Filed: May 7, 2004

(51) Int. Cl. G06F 7/00

(52) U.S. Cl. 707/100

(57) ABSTRACT

Systems and methods for correlating materials records to part records. At least one materials record is provided with a corresponding digital materials images and a plurality of parts records are provided with at least one corresponding digital parts image. The materials records are automatically compared to the part records, and potential matches are identified. Any digital materials images and parts images for the potential matches are displayed to the user for confirmation of a match.

### FIELD OF THE INVENTION

The present invention relates generally to the field of enterprise resource planning or asset management systems for maintaining assets, with common but by no means exclusive application to manufacturing or processing plants.

### BACKGROUND OF THE INVENTION

Large manufacturing and many other enterprises utilize fixed plant, equipment, machines or other assets (collectively referred to herein as “assets”) requiring repair and maintenance from time to time. Such enterprises often store replacement parts and maintain parts ordering records for critical assets. For the purposes of this application, a “part” may be a single component or an assembly composed of a number of individual components.

Computer systems have been developed such as enterprise resource planning systems (ERPs), enterprise asset management systems (EAMs) and computerized maintenance management systems (CMMS) (all referred to collectively herein as ERPs). Such ERPs may store replacement “materials” inventory records, materials ordering records, and may also store “bills of materials” (BOMs) which list frequently-replaced materials or components for a particular asset and may also identify materials to be replaced in an asset during regularly scheduled maintenance. Typically, materials are identified in ERPs by a unique stock keeping unit number (SKU) assigned by the enterprise.

Such ERPs are of use to enterprise procurement departments responsible for obtaining parts requested on work orders which list the corresponding material's SKU. However, ERPs are not particularly useful to engineers and other maintenance personnel who must identify the correct SKU for a particular part which needs replacing, in order to prepare the work order procurement request. Knowing how a particular part is identified in printed parts manuals (typically supplied by the original equipment manufacturer (OEM) or other parts supplier when an asset is purchased) available to the maintenance personnel is of no assistance in identifying the enterprise's SKU for the corresponding material. Losses in time, use of assets and money occur when the wrong material is mistakenly ordered.

The applicants have recognized a need for systems and methods for correlating ERP materials data with parts data typically available to maintenance personnel.

### SUMMARY OF THE INVENTION

In one aspect, the present invention is directed towards a method for identifying relationships between a plurality of materials records having materials text data and a plurality of parts records having parts text data. At least one parts record is correlated to at least one asset. The method includes the steps of:
(a) providing at least one digital materials image correlated to at least one of said materials records;
(b) comparing materials text data with parts text data and identifying at least one possible match of at least one materials record and at least one parts records;
(c) displaying any digital materials image correlated to said at least one possible match of at least one materials record and at least one parts record; and
(d) determining if a match exists between said possible match of at least one materials record and at least one parts record.

Preferably, the method also includes the steps of:
(a) providing at least one digital parts image correlated to at least one of said parts records; and
(b) displaying any digital parts image correlated to said possible match of at least one materials record and at least one parts record.

In another aspect, the present invention is directed towards a method for identifying relationships between a plurality of materials records comprising materials text data and a plurality of parts records comprising parts text data, wherein at least one of said parts records is correlated to at least one asset. The method includes the steps of:
(a) providing at least one digital parts image correlated to at least one of said parts records;
(b) comparing said materials text data with said parts text data and identifying at least one possible matches of at least one materials record and at least one parts record;
(c) displaying any digital parts image correlated to said possible match of at least one materials record and at least one parts record; and
(d) determining if a match exists between said possible match of at least one materials record and at least one parts record.

Preferably, the method also includes the steps of:
(a) providing at least one digital materials image correlated to at least one of said materials records; and
(b) displaying any digital materials image correlated to said possible match of at least one materials record and at least one parts record.

In yet another aspect, the present invention is directed towards a system for identifying relationships between a plurality of materials records having materials text data and a plurality of part records having part text data. Each parts record is correlated to at least one asset. The system includes a materials image database, a parts image database, a match engine having a comparator, a display and an input device.

The materials image database stores at least one materials image correlated to at least one of said material records. The parts image database stores at least one electronic parts image correlated to at least one of said parts records.

The comparator is configured to compare materials text data of a materials record with parts text data of a parts record and determine a matching weight correlated to the likelihood that the materials record matches the parts record.

Finally, the display is configured for displaying at least one digital materials image correlated to at least one materials record and for displaying at least one digital parts image correlated to at least one parts record, while the input means is adapted for receiving data correlated to whether a match exists between at least one materials record and at least one parts record.

In a further aspect, the invention is directed towards a materials database storing a plurality of materials records, wherein each materials record includes materials text data, and wherein said materials database further includes a materials image database having at least one digital materials image correlated to at least one materials record.

In yet another aspect, the invention is directed towards a parts database storing a plurality of part records, wherein each part record includes parts text data, and wherein said part database further includes a parts image database having at least one digital parts image correlated to at least one parts record.

### BRIEF DESCRIPTION OF THE DRAWINGS

The present invention will now be described, by way of example only, with reference to the following drawings, in which like reference numerals refer to like parts and in which:

FIG. 1 is a schematic diagram of a matching system made in accordance with the present invention.

FIG. 2A is a schematic diagram of example materials data records, as may be stored in the materials database of FIG. 1;

FIG. 2B is a schematic diagram of example bill of materials data records, as may be stored in the materials database of FIG. 1;

FIG. 2C is a schematic diagram of example work order data as may be stored in the materials database of FIG. 1;

FIG. 3A is a schematic diagram of example parts data records, as may be stored in the parts database of FIG. 1;

FIG. 3B is a schematic diagram of a parts data record from FIG. 3A which has been amended with tracking data;

FIGS. 4A, 4B & 4C are a flow diagram illustrating the steps of a method of the present invention; and

FIG. 5 is a schematic diagram of a screen display as may be presented by a user during operation of the matching system of the present invention.

### DETAILED DESCRIPTION OF THE INVENTION

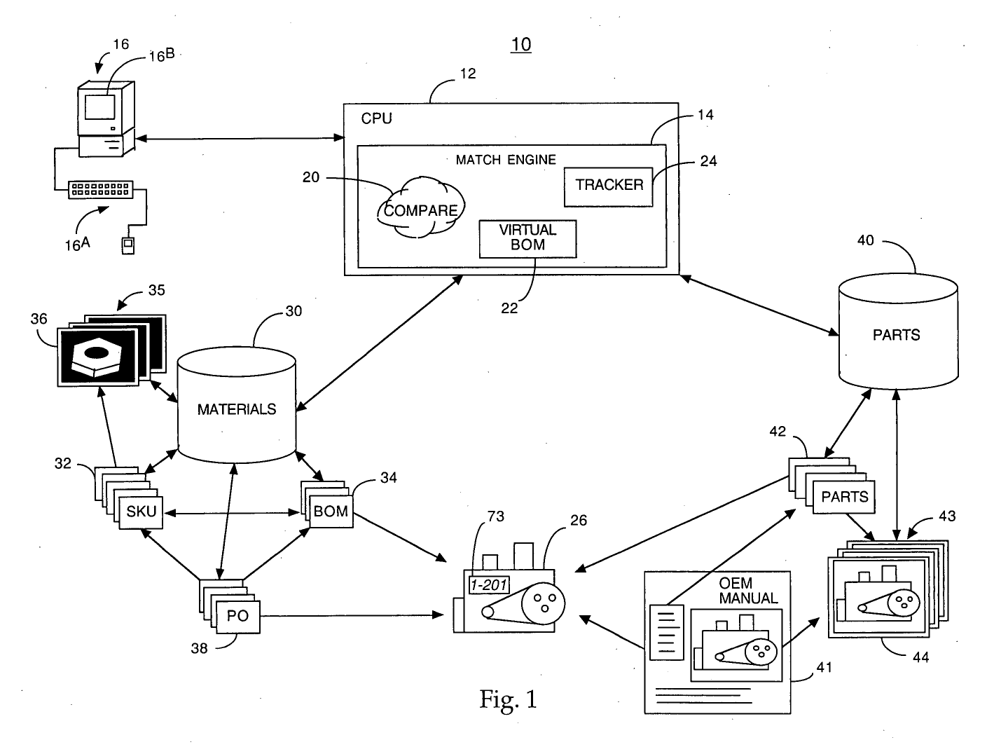

Referring to FIG. 1, illustrated therein is a matching system, referred to generally as 10, made in accordance with the present invention. The matching system 10 comprises a processor or central processing unit (CPU) 12 having a suitably programmed matching system engine 14 and an input/output device 16 (typically including an input component 16^{A} such as a keyboard, and an output component 16^{B} such as a display) also operatively coupled to the CPU 12.

The matching system engine 14 comprises a comparator module 20, configured for receiving two or more groups of typically (but not necessarily exclusively) textual data and generating a weighting value correlated to the degree of similarity between the two groups of data. An association module 22 (also referred to herein as a virtual BOM module) is also preferably provided, which analyzes purchase order, work order and other data sources which may be used to identify an association between materials and assets 26, and determines if any such associations exist. As well, a tracker module 24 may also be provided for tracking the progress of the system's 10 operation.

The CPU 12 is operatively coupled to a materials database 30 which typically stores tens of thousands of materials records 32, depending on the size and complexity of an enterprise's operations. The materials database 30 may also store BOM records 34, each typically correlated to an asset 26 as well as a plurality of materials records 32. As noted, BOMs 34 list frequently-replaced materials 32 or components for a particular asset 26 and may also identify materials 32 to be replaced in an asset 26 during maintenance or repair activities.

A materials image database 35 correlated to the materials records 32 may also be provided, which preferably contains an image 36 (typically a digital photograph or other digital picture or diagram) for each of many or all of the materials 32. When used herein, “digital” is intended to refer to any digital, electronic or similar means for storing, manipulating and representing textual or image data. The materials database 30 may also store purchase order or other procurement data 38.

The CPU 12 is also operatively coupled to a parts database 40 which typically stores parts data typically culled from parts manuals 41 and other sources. The database 40 typically stores tens of thousands of parts records 42, along with a database 43 of corresponding electronic images of assembly or parts diagrams 44.

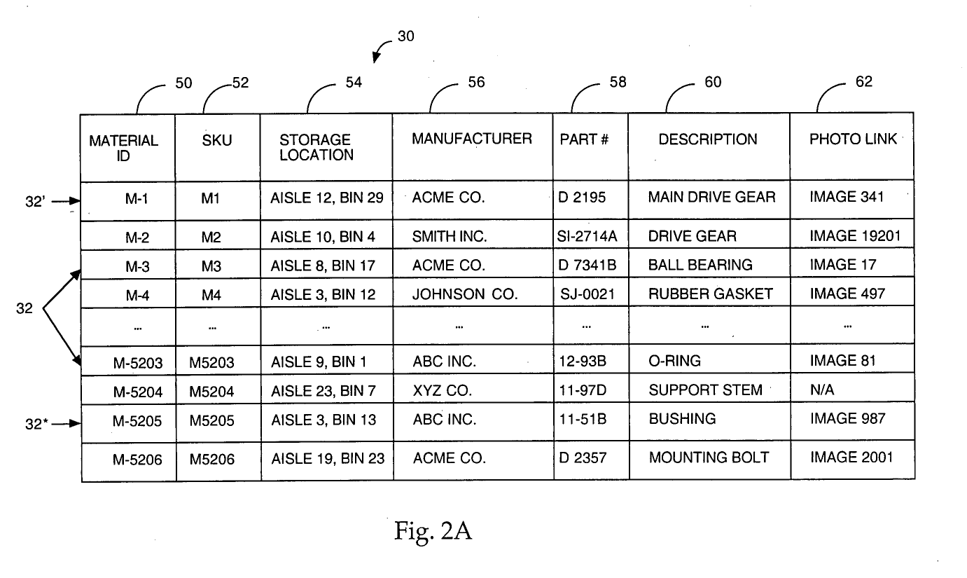

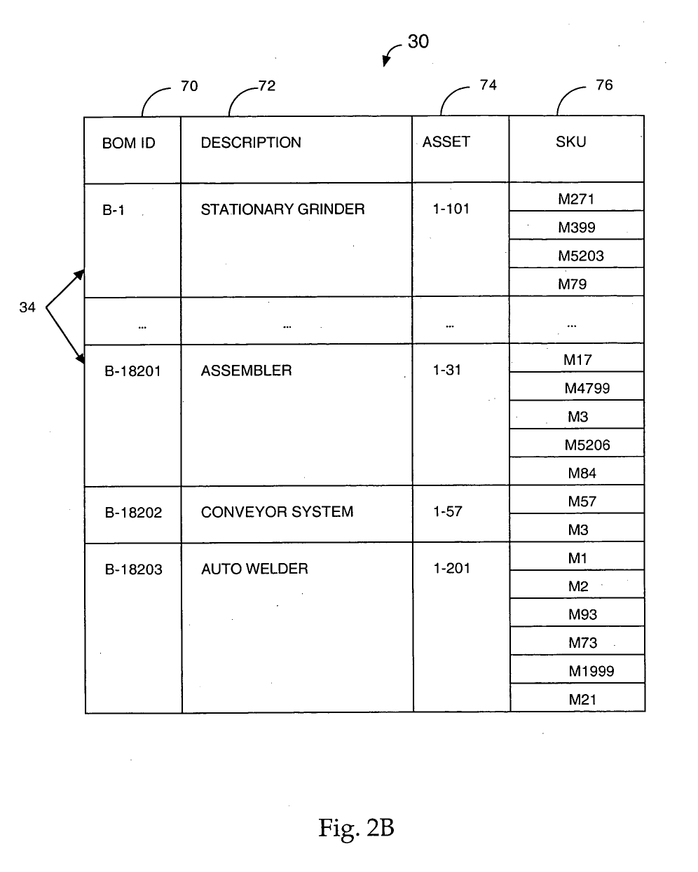

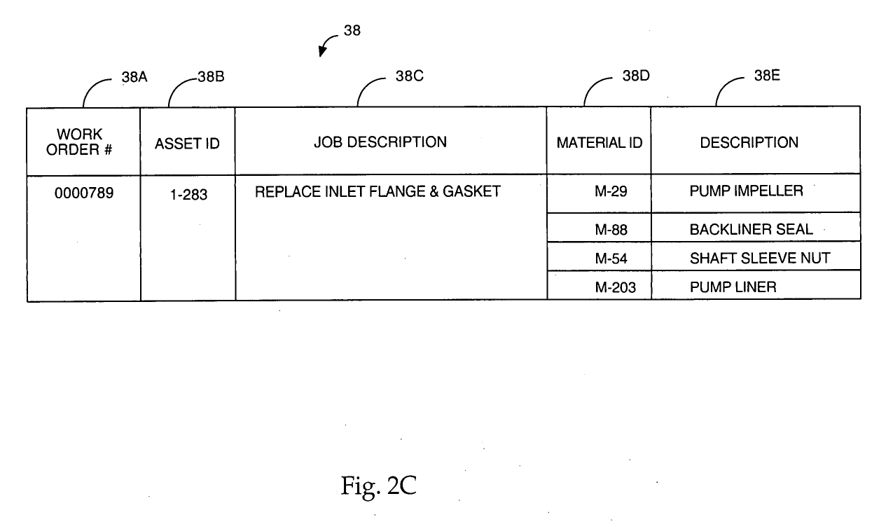

Referring now to FIG. 2A, illustrated therein is an example of the type of materials records 32 data typically stored in the materials database 30. Typically the materials record 32 data will be determined and entered into the database 30 by the enterprise procurement department when a material 32 is to be purchased for the first time.

The sample materials records 32 include different fields of mostly textual data (materials text data). Most of this textual data has typically been downloaded from the ERP and preferably massaged as necessary to optimize the matching process described herein. A materials identifier field 50 contains data indicating a unique identifier for each of the materials records 32 in the database 30. Typically this identifier 50 is transparent to the user, and is used by the system 10 in correctly manipulating other data stored in the record 32. An SKU field 52 contains a unique stock keeping identifier assigned by the enterprise.

A storage location field 54 stores data corresponding to the physical location or locations in the enterprise, where spares of the material 32 are stored (if spares are in fact kept on hand by the enterprise). As will be understood, sophisticated ERP systems may also track and store data representing quantities of materials currently stored by the enterprise (not shown).

A materials manufacturer field 56 stores data which identifies the manufacturer and/or the supplier of the material 32. Typically, the materials record 32 will also store the manufacturer's/supplier's contact data (not shown) for placing an order for additional material 32. A materials part number field 58 is provided for storing the manufacturer's/supplier's part number for reordering purposes. A written description of the material 32 (which may include various identifiers, such as, for example the size, configuration and material properties) is also preferably stored in one or more materials description fields 60.

Preferably, a materials image identifier field 62 is also provided which stores data linking the materials record 32 to the corresponding materials image 36, if one exists. Preferably during an audit, a digital image will be made of each of the materials 32 (typically by materials image means, such as a digital camera) stocked by the enterprise, and stored in the materials image database 35, with a link to the image 36 being stored in the image identifier field 62 of the corresponding material record 32. As materials 32 are ordered over time, any materials 32 for which an image 36 has not been obtained will preferably be identified and a photograph taken and stored in the image database 35.

Referring now to FIG. 2B, illustrated therein is an example of the type of BOM record 34 data typically stored in the material database 30. As with the materials records 32, the BOM records 34 include different fields of mostly textual data. A BOM identifier field 70 contains data indicating a unique BOM identifier for each of the BOM records 34 in the database 30.

A written description of the BOM is also preferably stored in a BOM description field 72. An asset identifier field 74 is provided which stores data identifying which asset (for example, a piece of equipment or machine or subassembly) 26 the BOM record 34 relates to. As will be understood, most assets 26 in an enterprise are uniquely labeled and provided with an asset identifier for maintenance purposes. Typically the unique asset identifier printed on such a label 73 is stored in the asset identifier field 74. More than one BOM record 34 may relate to the same asset 26, and a BOM record 34 may relate to more than one asset 26.

A SKU field 76 stores the stock keeping identifier assigned by the enterprise for each of the materials 32 associated with an asset 26 which are commonly replaced when the BOM 34 is utilized. The SKU data 76 provides a mechanism for cross-referencing the BOM records 34 to the materials records 32 storing matching SKU data 52.

Complex BOM records (not shown) may store data hierarchically by sub-assembly or component of the associated asset 26. As will be understood, sophisticated ERP systems may also track and store scheduling data corresponding to when the BOM 34 (or more typically the portion of a BOM record 34 relating to a component or sub-assembly) is scheduled to be implemented (not shown), if the BOM 34 is designed for preventive or recurring maintenance and not simply in response to the requirements for a repair.

FIG. 2C illustrates an example of the type of work order (or purchase order) record data 38 the ERP database may also store. A work order identifier field 38A may be provided for storing a unique work order identifier. An asset identifier field 38B may be provided which stores data identifying which asset 26 the work order relates to. A job description field 38C may provide a description of the maintenance work to be performed. Material identifier 38D and description 38E fields serve to identify the materials required to perform the maintenance work.

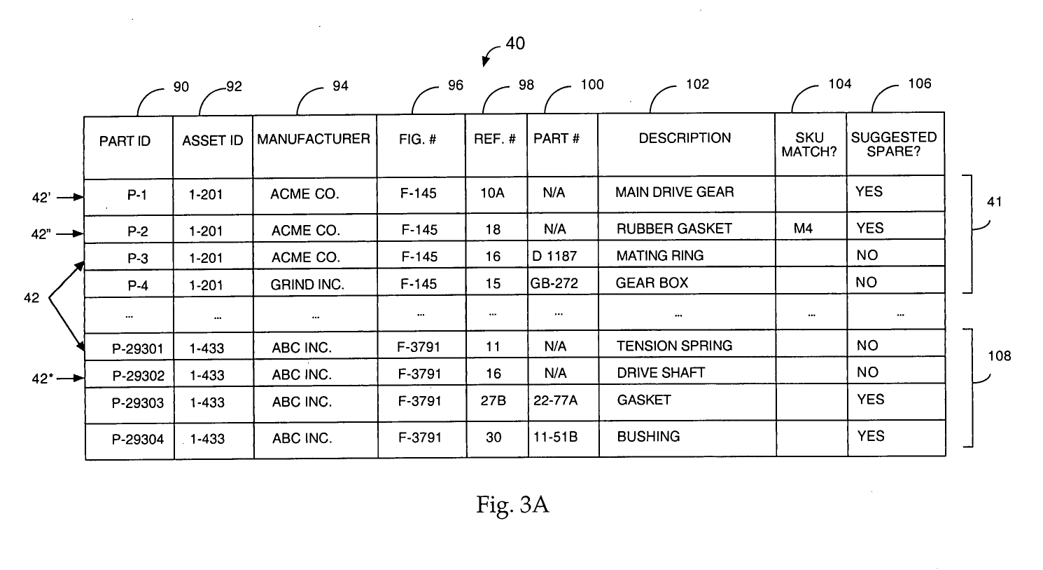

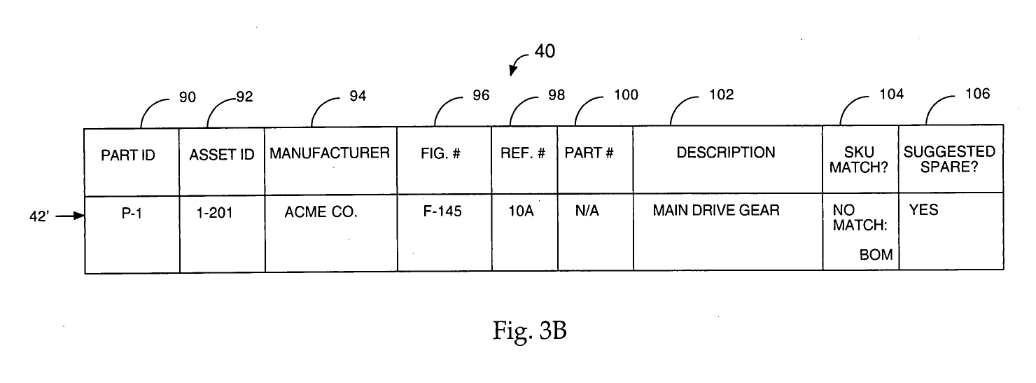

Turning now to FIG. 3A, illustrated therein is an example of the type of data typically stored in a parts database 40. As will be understood, typically the data stored in a parts record 42 will be obtained (and, if necessary, electronically converted) from parts manuals 41, 108 supplied by the OEM (or other supplier) when an asset 26 is purchased or modified. A large enterprise may have hundreds or even thousands of different parts manuals 41, 108, each of which in turn may list tens, hundreds or thousands of different parts 42. An original image of the OEM parts list and other data from the manuals 41, 108 may be stored as an intact item of data for future reference.

The sample record 42 includes different fields of mostly textual data (parts text data). A part identifier field 90 contains data indicating a unique identifier for each of the part records 42 in the database 40. Typically this identifier 90 is transparent to the user, and is used by the system 10 in correctly manipulating other associated data in the record 42. An asset identifier field 92 contains data identifying which asset or assets 26 the part data is correlated to or associated with. Typically the unique asset identifier printed on an asset label 73 is stored in the asset identifier field 92.

A manufacturer field 94 stores data which identifies the manufacturer of the part 42. A figure number field 96 and a reference number field 98 are also provided. As will be understood, typically OEM manuals 41 include a parts/assembly diagram illustrating the various parts and components in the asset 26, and their location in the assembled asset 26. Each such part is typically identified by number in the diagram, and that reference number is stored in the reference field 98. The figure number data 96 provides a link or index to a corresponding parts diagram 44 stored in the electronic parts database 40.

If the OEM has provided the OEM's unique part identification number, this data is stored in the part number field 100. However, a manufacturer will not always provide its replacement part numbers with its manuals. As well, replacement part numbers may change over time. A written description of the part 42 is also preferably stored in a description field 102. A SKU field 104 is also provided to store any SKU identifiers (or tracking data) as the matching process is performed, which will be discussed in greater detail, below.

Preferably, a recommended spare field 106 is also provided. In parts manuals 41, 108 OEMs typically identify parts of assemblies which require frequent replacement, and for which spares should be kept on hand. Data correlated to whether or not the OEM has recommended, or the owner/operator has determined based upon its experience or analysis, that spares of a part 42 should be kept, is stored in the spare field 106.

As will be understood, the materials database 30 and the parts database 40 may be stored within data storage local to the CPU 12, or remotely such that the databases 30, 40 are typically accessed through a communications network such as the Internet.

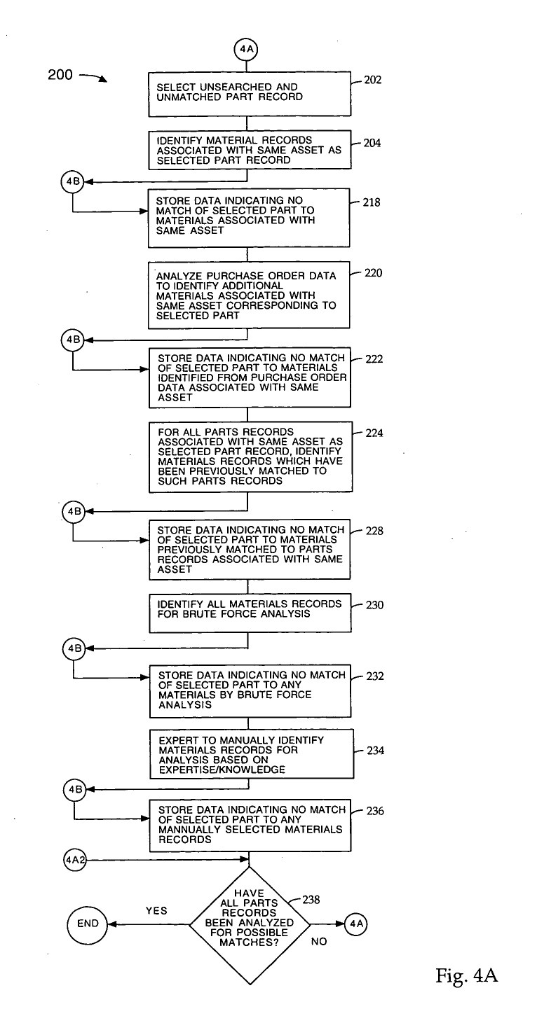

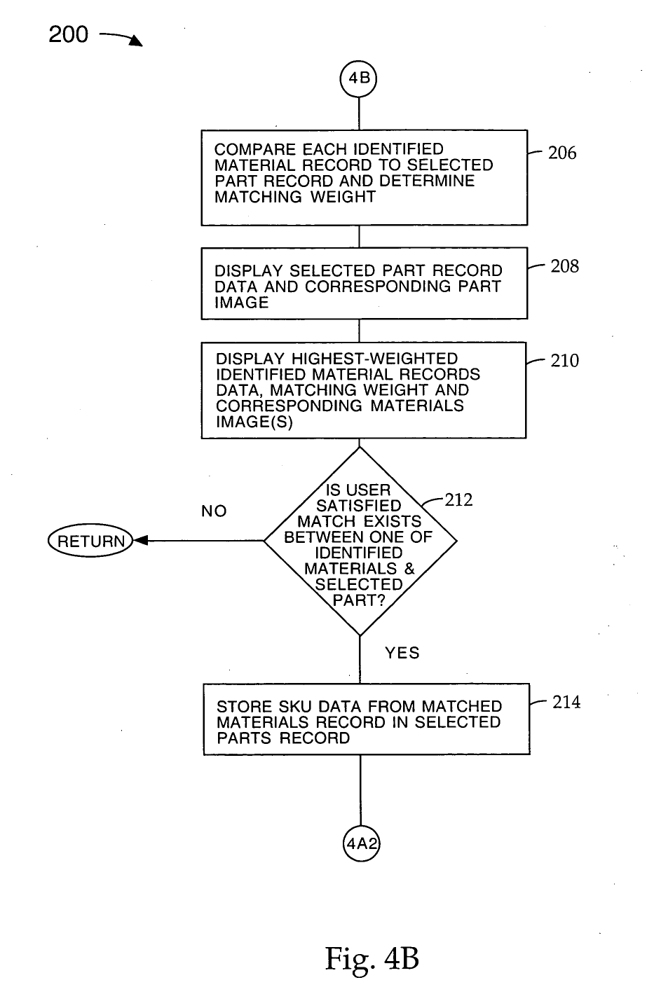

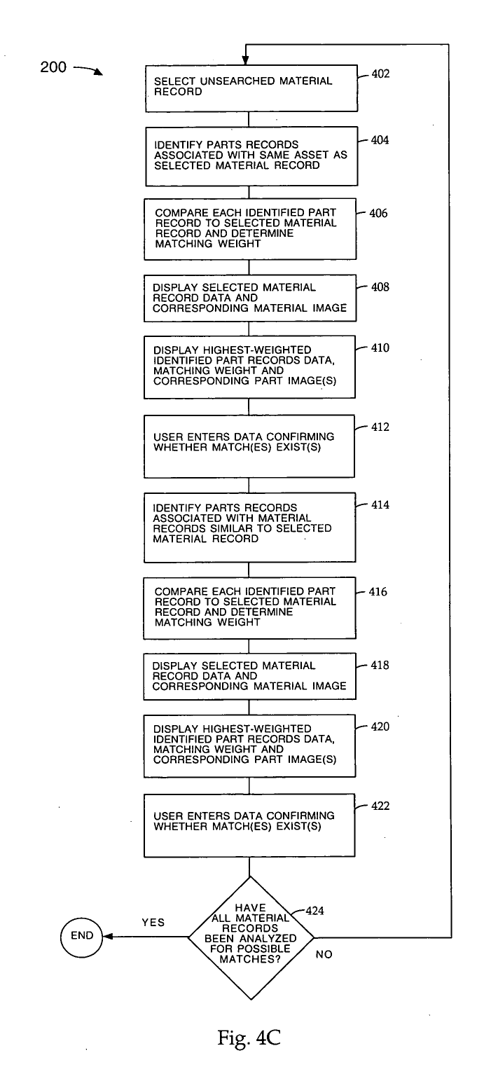

Referring now to FIGS. 4A & 4B (in conjunction with FIGS. 1, 2A, 2B & 3A), illustrated therein is one embodiment of the general process, referred to generally as 200, which the matching system 10 performs. The matching engine 14 first selects a part record 42′ from the parts database 40 for which no SKU matching data 104 has been stored (Block 202).

The engine 14 then identifies all material records 32′ associated with the corresponding asset 26 (Block 204). To perform this task, the engine 14 may query the materials database 30 to identify all BOM records 34 having an asset identifier 74 matching the asset identifier 92 for the selected part 42′. Each material record 32 associated with the identified BOMs 34 (ie. for which the SKU identifiers 52, 76 match) is identified by the engine 14.

Preferably using fuzzy logic, the comparator module 20 systematically compares the textual data 94, 100, 102 identifying and describing the selected part 42′, to the corresponding textual data 56, 58, 60 for each of the identified materials 32′. The comparator module 20 calculates a matching weight 150 for each identified material 32′ correlated to the likelihood that the selected part 42′ is the same as the identified material 32′ (Block 206).

Preferably, the comparator 20 will be programmed to first compare the manufacturer data 56, 94 and the part numbers 58, 100—if the data matches, a 100% matching weight 150 will be returned. Preferably, too, the comparator 20 is programmed to allow users to input textual relationships to be used in the matching process, for example, that “AlphaBeta Corp.” is the same as “ABC Co.”.

As should also be understood, the parameters utilized by the comparator 20, such as for example the amount of data compared, fields compared, and target probability weighting, can be adjusted to improve the number and quality of suggested matches and corresponding matching weight 150.

The engine 14 then retrieves from the parts diagram database 43 the parts diagram 44 corresponding to the selected part 42′ (via the Figure link data 96). Pertinent textual data 94, 100, 102 which will assist the user in determining if a match to an identified material 32′ exists, is then displayed to the user on the display 16^{B} along with the corresponding part image or diagram 44′ (Block 208). Textual data 52, 56, 58, 60 for the highest-weighted potential materials matches 32′ will also be displayed to the user on the display 16^{B}, along with any corresponding materials image 36, and the calculated matching weight 150 (Block 210).

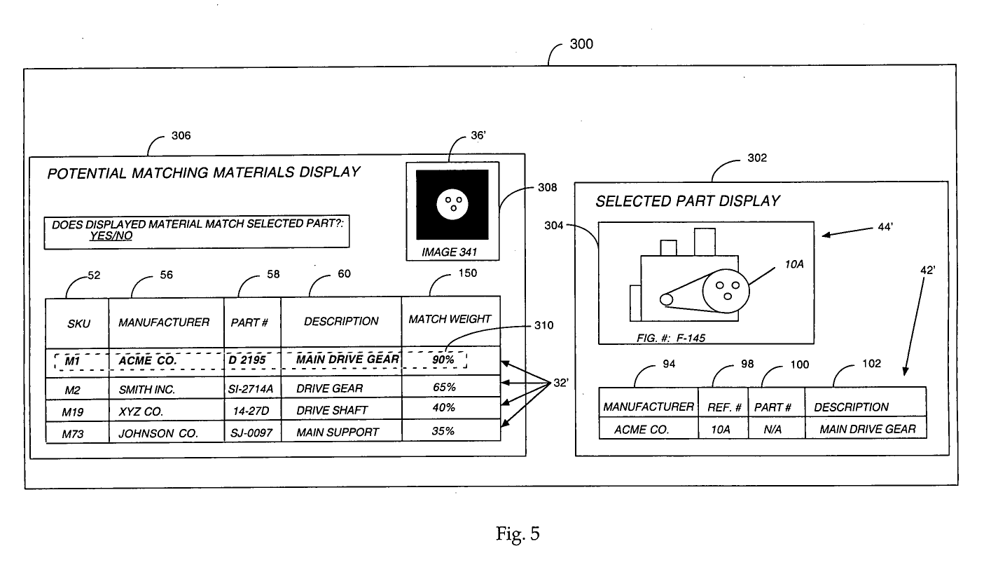

FIG. 5 illustrates a screen display 300 as may be presented to a user on the display 16^{B} following completion of Blocks 208 and 210. In a selected part display portion 302, the display 300 presents useful textual data 94, 100, 102. The selected part display portion 302 also preferably includes a parts image display portion 304 which displays the corresponding parts diagram 44′ for the selected part 42′. Preferably, the part 42′ is highlighted or otherwise identified in the displayed parts diagram 44′ for easy visual identification.

A potential matching materials display portion 306 of the display 300 is configured to display the textual data 52, 56, 58, 60 for the highest-weighted of the identified materials 32′ which potentially match the selected part 42′, along with the corresponding match weight 150 values. A materials image display portion 308 of the screen display 300 is configured to display at least one selected materials image 36′ from the displayed highest-weighted materials 32′. Typically, the user will be able to scroll through the list of highest-weighted materials 32′, with the corresponding materials image 36′ of the highlighted material 310 being displayed.

By displaying the descriptive materials information 52, 56, 58, 60 and the materials images 36′ in conjunction with the descriptive parts information 94, 100, 102 and the parts diagram 44′, the user is able to make an informed decision as to whether a potential material 32′ is or is not an actual match to the selected part 42′.

If the user determines that a potential material 32′ matches the selected part 42′, that determination is input via the input device 16^{A}, and received by the engine 14 (Block 212). The tracker module 24 is then configured to store the material's 32′ SKU identifier 52 in the SKU match data field 104 for the selected part 42′ (Block 214). As will be understood, in complex embodiments of the invention, the determination made by the user may include different types of status other than simply indicating a match or no match. The engine 14 selects another unmatched part record 42, and repeats the process commencing at Block 202, until all part records 42 have been analyzed for potential matches to material records 32.

Furthermore, in complex embodiments of the invention, a match may be accepted for all assets 26 of a similar type, or only for one specific asset 26. For example, two similar assets 26 may have different tension springs, even though the part identifier 100 does not distinguish the types of springs which can be used. Accordingly, in such an embodiment, one part 42 may be matched to more than one material 32, and more than one SKU identifier 52 may be stored in the SKU match field 104.

If the user determines that none of the potential materials 32′ matches the selected part 42′, the tracker module 24 stores data in the SKU match data field 104 for the selected part 42′ indicating that comparison of the BOM records 34 data to the selected part 42′ did not result in a match (Block 218).

For example, FIG. 3B illustrates the type of SKU match data 104 as may be stored by the tracker module 24 in selected part record 42′ having part identification number P-1, in Block 218.

If a match has not been identified, the virtual BOM module 22 is configured to analyze any stored purchase order or other material requisition or work order data 38 to identify any materials 32 not otherwise listed in a BOM record 34 but which are associated with the asset 26 corresponding to the selected part 42′ (Block 220). The SKU data 52 for the identified materials records 32′ are then stored in the BOM record 34 (or alternatively in a temporary “Virtual BOM” record 34) associated with such asset 26, as possible matches for the selected part 42′ or other parts 42 associated with that asset 26.

The steps outlined above with respect to Blocks 206-212 (and 214, if appropriate) are repeated with the visual and textual data corresponding to the highest-weighted potential matches of materials 32′ displayed to the user for comparison to the visual and textual data for the selected part 42′.

If the user is unable to match any of the potential materials 32′ to the selected part 42′ (either because the user confirmed no match exists or is unable to make that determination based on the displayed information), the tracker module 24 stores data in the SKU match data field 104 for the selected part 42′ indicating that comparison of the materials data suggested as a result of analysis of the purchase order data 38 to the selected part 42′ did not result in a match (Block 222).

If a match still has not been identified, the engine 14 then identifies all materials records 32′ which have previously been SKU matched to parts records 42″ associated with the same asset 26 as the selected part record 42′ (Block 224). To perform this task, the engine 14 may query the parts database 40 to identify all parts records 42″ having an asset identifier 92 matching the asset identifier 92 for the selected part 42′, and having SKU match data 104 confirming that the identified parts record 42″ has been matched to a corresponding materials record 32.

The steps outlined above with respect to Blocks 206-212 (and 214, if appropriate) are repeated with the visual and textual data corresponding to the highest-weighted potential matches of materials 32′ displayed to the user for comparison to the visual and textual data for the selected part 42′.

If the user determines that none of the potential materials 32′ matches the selected part 42′, the tracker module 24 stores data in the SKU match data field 104 for the selected part 42′ indicating that comparison of materials matched with associated parts records 42″ to the selected part 42′ did not result in a match (Block 228).

If a match still has not been identified, the comparator module 20 performs a brute force analysis of every material record 32 in the materials database 30, regardless of association to any particular assets 26, and calculates a matching weight 150 for each material 32′ correlated to the likelihood that the selected part 42′ is the same as the identified material 32′ (Block 230).

Again, the visual and textual data corresponding to the highest-weighted potential matches of materials 32′ are displayed to the user for comparison to the visual and textual data of the selected part 42′, as the steps outlined above with respect to Blocks 206-212 (and 214, if appropriate) are repeated.

If the user determines that none of the potential materials 32′ matches the selected part 42′, the tracker module 24 stores data in the SKU match data field 104 for the selected part 42′ indicating that brute force comparison to all the materials records 32 did not result in a match (Block 232).

Additionally, using his or her expertise or familiarity with the assets, the user may manually identify one or more specific materials 32′ for comparison to the selected part 42′ (Block 234). The visual and textual data corresponding to the selected materials 32′ is displayed to the user for comparison to the visual and textual data of the selected part 42′, and the steps outlined above with respect to Blocks 206-212 (and 214, if appropriate) are repeated.

If the user determines that none of the manually identified materials 32′ matches the selected part 42′, the tracker module 24 stores data in the SKU match data field 104 for the selected part 42′ indicating that comparison of the manually identified materials 32′ to the selected part 42′ did not result in a match (Block 236).

If a match has been confirmed by the user, or if no match has been found, the engine 14 repeats the matching process by selecting another part record 42 for which no SKU matching data 104 has been stored (at Block 202), until all part records 42 have either been matched or have been confirmed as having no match to a corresponding materials record 32 through the various different comparison approaches.

The matching process 200 has been illustrated and described as performing numerous different types of matching analyses identified generally in Blocks 204, 220, 224, 230 and 234, which are generally directed at matching selected parts 42′ to material records 32. Alternatively, or in addition to such matching analyses 204, 220, 224, 230, 234, the matching process 200 may also select material records 32 to attempt to match them to parts records 42.

For example, as illustrated in FIG. 4C, the matching engine 14 may select an unsearched material record 32* from the materials database 30 to attempt to match it to one or more parts records 42 (Block 402). As will be understood, typically the tracker module 24 will store data correlated to whether all of the types of searches have been conducted for matching a particular material record 32.

The engine 14 then identifies all parts records 42* associated with the corresponding asset (Block 404). To perform this task, the engine 14 may query the materials database 30 to identify all BOM records 34 (which may also include virtual BOM record data generated by the virtual BOM module 22 along the lines discussed above in connection with Block 220) having SKU data 76 matching the SKU data 52 for the selected material 32*. Each parts record 42 associated with the identified BOMs 34 (ie. for which the asset identifiers 74, 92 match) is identified by the engine 14.

Preferably using fuzzy logic, the comparator module 20 systematically compares the textual data 56, 58, 60 identifying and describing the selected material 32*, to the corresponding textual data 94, 100, 102 for each of the identified parts 42*. The comparator module 20 calculates a matching weight 150 for each identified part 42* correlated to the likelihood that the selected material 32* is the same as the identified part 42* (Block 406).

In a similar manner as for the matching analyses described previously in connection with FIGS. 4A & 4B, textual data 52, 56, 58, 60 for the selected material 32* will be displayed to the user on the display 16^{B}, along with the corresponding materials image 36 (Block 408). Textual data 94, 100, 102 for the highest-weighted potential parts matches 42* will also be displayed to the user on the display 16^{B}, along with any corresponding parts image 44, and the calculated matching weight 150 (Block 410) for comparison and input by the user (Block 412). The tracker module 24 will also store data correlated to the data input by the user.

As will be understood, the screen display will look generally similar to the display 300 illustrated in FIG. 5, but will be provided with a selected material display portion (in place of the selected part display portion 302), and a potential matching parts display portion (in place of the potential matching materials display portion 306), and with similar corresponding changes.

In another type of matching analysis, the engine 14 may identify all parts records 42 associated with materials records 32 similar to the selected material record 32* (Block 414). To perform this task, the comparator module 20 may compare the selected materials record 32* to each of the other materials records 32 and determine a matching weight. For each such matching materials record 32 above a pre-determined threshold (eg. 40%), the engine 14 then identifies all parts records 42* associated with the asset 26 corresponding to the matching materials record 32 in a similar manner as described in relation to Block 404.

In Blocks 416-422, the visual and textual data corresponding to the highest-weighted potential matches of parts 42* are displayed to the user for comparison to the visual and textual data for the selected material 32*, with corresponding input by the user. The process 200 may be repeated until all materials 32 have been analysed for potential matches to parts records 42 (Block 424).

While the matching process 200 has been illustrated and described as performing numerous different types of matching analyses identified generally in Blocks 204, 220, 224, 230 and 234, in a linear fashion, it should be understood that each of such analytical steps 204, 220, 224, 230 and 234 may or may not be performed, or may be performed in a different order than described. Matching analyses other than those described herein may also be performed by the system 10, without departing from the subject invention.

Furthermore, the matching process 200 has been illustrated and described as displaying data to the user (see eg. Blocks 208-212) following completion of each of the different types of matching analyses identified generally in Blocks 204, 220, 224, 230 and 234 and 404 and 414. However, it should be understood that some or all of the different analysis 204, 220, 224, 230, 234 and 404 and 414 may be performed by the matching engine 14 substantially at one time, with the results for each type of analysis selectively presented on the display 16^{B} for comparison and input from the user.

As noted, preferably, the system 10 will include a tracking system 24 designed to store tracking data to track the matching process steps completed by the user during the matching process 200. As will be understood, some matching processes 200 may require substantial computational time and user time to generate and view the various possible matches. Accordingly, it is often not possible for a single user to complete all of the steps in a process 200 for even a single selected part 42′ without interruption. It may be necessary for the user, or even for another individual, to resume the matching process 200 at a later date. The tracking data facilitates such a resumption of the process 200 analysis.

Additionally, in view of the substantial computational time involved in determining possible matches, some or all of the computations for the various matching analyses may be batch processed, with the results stored in temporary storage for access when the user commences or resumes the matching process 200.

The system 10 and tracking system 24 are also preferably configured to facilitate and monitor multiple users using the system 10 at one time. As will be understood, such a configuration permits the division of the part database 40 into groups of parts 42 (or materials database 30 into groups of materials 32) to enable multiple users to review potential matches simultaneously, and thereby complete the matching process 200 for all of the parts 42 (or materials 32) more expeditiously.

As well, the tracking system 24 may also be designed to track and store potential match condition data 104 indicating that the user cannot determine if a match exists between a material 32 and a part 42. Such tracking data allows for efficient allocation of expert's time: relatively inexperienced users may perform the bulk of the analysis, identifying routine matches (or non-matches), and identifying those potential matches that require a user having greater expertise to make a final determination.

Thus, while what is shown and described herein constitute preferred embodiments of the subject invention, it should be understood that various changes can be made without departing from the subject invention, the scope of which is defined in the appended claims.

1. A method for identifying relationships between a plurality of materials records comprising materials text data and a plurality of parts records comprising parts text data, wherein at least one of said parts records is correlated to at least one asset, said method comprising the steps of:
(a) providing at least one digital materials image correlated to at least one of said materials records;
(b) comparing said materials text data with said parts text data and identifying at least one possible match of at least one materials record and at least one parts record;
(c) displaying any digital materials image correlated to said possible match of at least one materials record and at least one parts record; and
(d) determining if a match exists between said possible match of at least one materials record and at least one parts record.

2. The method as claimed in claim 1, further comprising the steps of:
(a) providing at least one digital parts image correlated to at least one of said parts records; and
(b) displaying any digital parts image correlated to said possible match of at least one materials record and at least one parts record.

3. The method as claimed in claim 2, further comprising the step of correlating at least one materials record to at least one asset.

4. The method as claimed in claim 3, wherein the step of correlating at least one materials record to at least one asset comprises analyzing data selected from the set consisting of materials purchase order data and work order data.

5. The method as claimed in claim 3, comprising the step of storing bill of materials data corresponding to at least one asset.

6. The method as claimed in claim 3, wherein step (b) of claim 1 comprises selecting a materials record and identifying at least one parts record associated with the same asset as the selected materials record.

7. The method as claimed in claim 3, wherein step (b) of claim 1 comprises performing a fuzzy logic comparison of parts text data and materials text data.

8. The method as claimed in claim 7, further comprising determining a matching weight value corresponding to the likelihood of a match existing between a materials record and a parts record.

9. The method as claimed in claim 2, further comprising the step of tracking the matching process steps completed during the matching process.

10. The method as claimed in claim 9, comprising storing tracking data correlated to each parts record, wherein said tracking data is configured to indicate if a parts record has been matched to at least one materials record.

11. The method as claimed in claim 10, wherein said tracking data is configured to indicate a potential match condition.

12. The method as claimed in claim 2, wherein step (b) of claim 1 comprises the step of identifying at least one parts record associated with at least one associated materials record similar to a selected materials record.

13. A computer readable medium storing program code, which when executed on a computer, cause the computer to perform the method of claim 1.

14. A system for identifying relationships between a plurality of materials records comprising materials text data and a plurality of parts records comprising parts text data, wherein each of said parts records is correlated to at least one asset, the system comprising:
(a) a materials image database storing at least one digital materials image correlated to at least one materials record;
(b) a parts image database storing at least one parts image correlated to at least one parts record;
(c) a match engine having:
(i) a comparator configured to compare materials text data of a materials record with parts text data of a parts record and determine a matching weight correlated to the likelihood that the materials record matches the parts record;
(d) a display for displaying at least one digital materials image correlated to at least one materials record and for displaying at least one digital parts image correlated to at least one parts record; and
(e) input means for receiving data correlated to whether a match exists between at least one materials record and at least one parts record.

15. A materials database comprising a plurality of materials records, wherein each materials record comprises materials text data, and wherein said materials database further comprises a materials image database comprising at least one digital materials image correlated to at least one materials record.

16. A parts database comprising a plurality of part records, wherein each part record comprises parts text data, and wherein said part database further comprises a parts image database comprising at least one digital parts image correlated to at least one parts record.

17. A method for identifying relationships between a plurality of materials records comprising materials text data and a plurality of parts records comprising parts text data, wherein at least one of said parts records is correlated to at least one asset, said method comprising the steps of:
(a) providing at least one digital parts image correlated to at least one of said parts records;
(b) comparing said materials text data with said parts text data and identifying at least one possible match of at least one materials record and at least one parts record;
(c) displaying any digital parts image correlated to said possible match of at least one materials record and at least one parts record; and
(d) determining if a match exists between said possible match of at least one materials record and at least one parts record.

18. The method as claimed in claim 17, further comprising the steps of:
(a) providing at least one digital materials image correlated to at least one of said materials records; and
(b) displaying any digital materials image correlated to said possible match of at least one materials record and at least one parts record.

19. A computer readable medium storing program code, which when executed on a computer, cause the computer to perform the method of claim 17.
